(19) United States
(12) Patent Application Publication
(10) Pub. No.: US 2018/0305970 A1
(43) Pub. Date: Oct. 25, 2018

(54) REMOTE CONTROLLED MOTORIZED WINDOW COVERING

(71) Applicant: TTI (MACAO COMMERCIAL OFFSHORE) LIMITED, Macau (MO)

(72) Inventors: J. Porter Whitmire, Greenville, SC (US); Philip Scott Peterman, Greer, SC (US); Sean Hilliard, Raleigh, NC (US)

(21) Appl. No.: 15/956,581

(22) Filed: Apr. 18, 2018

Related U.S. Application Data
(60) Provisional application No. 62/487,380, filed on Apr. 19, 2017.

(51) Int. Cl. E06B 3/44; H04L 12/28; E06B 3/30

(52) U.S. Cl. CPC E06B 3/44; H04L 12/2816; H04L 2012/2841; H04L 2012/285; E06B 3/30

(57) ABSTRACT

A window covering assembly is remotely manipulated. A user may send instructions to the window covering assembly to raise or lower the window cover by utilizing an application installed on a smartphone or by way of a remote control. A hub may be provided to receive instructions from the user and to pass those instructions to one or more window covering assemblies.

This application claims the benefit of U.S. Provisional Application No. 62/487,380, filed Apr. 19, 2017, the contents of which are hereby incorporated by reference in their entirety.

### SUMMARY OF THE INVENTION

The present invention relates to a window covering assembly, and more particularly, to such an assembly that is remotely manipulated. In one embodiment, a user directs the window covering assembly to raise or lower the window cover via an application on a smartphone or a dedicated remote control. A central hub may be provided to receive the instructions that the user sends via the smartphone or remote control and transmits those instructions to the target window covering assembly.

### BRIEF DESCRIPTION OF THE DRAWING

FIG. 1 is a block diagram showing a network of window covering assemblies that may be remotely manipulated and the devices that may be used to carry out the manipulations.

### DETAILED DESCRIPTION OF THE PREFERRED EMBODIMENT

Reference will now be made in detail to the preferred embodiment of the present invention, which is illustrated in the accompanying drawing.

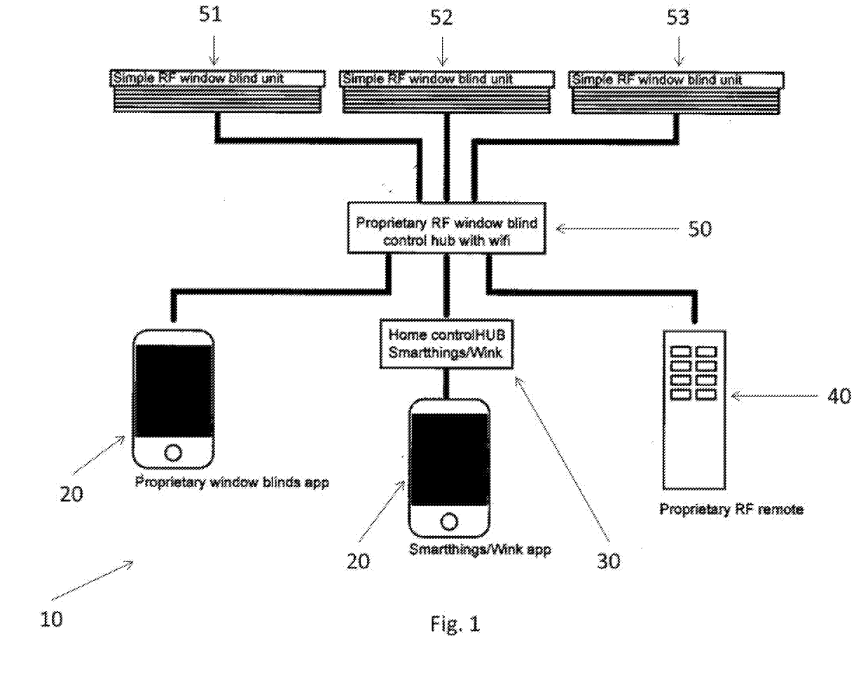

FIG. 1 shows a block diagram of a network 10 of window covering assemblies 51, 52, 53 that may be remotely manipulated and the devices 20, 40 that a user may use to remotely manipulate the window covering assemblies 51, 52, 53. Three window covering assemblies are shown in FIG. 1; however, any number of window covering assemblies may be employed.

As shown in FIG. 1, a control hub 50 may be provided that communicates with the window covering assemblies 51, 52, 53 via radio frequency (RF). As is also shown in FIG. 1, hub 50 also may communicate with one or more devices that a user may use to manipulate the blinds. Such a device may be a smartphone 20. A proprietary application may be installed on smartphone 20 that allows for the user to manipulate one or more of window covering assemblies 51, 52, 53.

Alternatively, a home automation platform may be installed on smartphone 20, in which case the smartphone communicates with a home control hub 30 for the platform. This platform 30 then communicates with the hub 50, as shown in FIG. 1.

As yet another alternative, a user may use a proprietary RF remote 40. This remote may include buttons to effect preprogrammed manipulations (for example, raising window covering, lower window covering) and buttons to indicate which window covering assemblies are the target of subsequent instructions.

By way of the foregoing a user may raise or lower one or more window covering. Additionally, other manipulations may be carried out remotely. For example, light modules that may be installed on the window covering assemblies 51, 52, 53 may be turned on or turned off remotely.

It will be apparent to those skilled in the art that various modifications and variations can be made in the modular motorized window blinds assembly of the present invention without departing from the spirit or scope of the invention. Thus, it is intended that the present invention cover modifications and variations of this invention provided they come within the scope of the appended claims and their equivalents.

What is claimed is:

1. A window covering assembly comprising:
a roller;
a motor assembly;
a window cover; and
a radio frequency receiver, wherein
the window cover is attached to the roller,
the window cover is raised when the roller rotates in a first angular direction,
the window cover is lowered when the roller rotates in a second angular direction, opposite the first angular direction,
the motor assembly interfaces with the roller via a power transmission system, and
the radio frequency receiver is configured to receive instructions that manipulate the window covering assembly.

2. A system comprising:
a window covering assembly comprising:
a roller;
a motor assembly;
a window cover; and
a radio frequency receiver, wherein
the window cover is attached to the roller,
the window cover is raised when the roller rotates in a first angular direction,
the window cover is lowered when the roller rotates in a second angular direction, opposite the first angular direction,
the motor assembly interfaces with the roller via a power transmission system, and
the radio frequency receiver is configured to receive instructions that manipulate the window covering assembly,
a control hub;
one or more window covering assemblies; and
an input device configured to receive manipulation instructions from a user.
